(19) United States
(12) Patent Application Publication
(10) Pub. No.: US 2006/0207546 A1
(43) Pub. Date: Sep. 21, 2006

(54) Engine system

(76) Inventor: Paul Y. Bechtel, Phoenix, AZ (US)

Correspondence Address: ROBERT A. PARSONS, 4000 N. CENTRAL AVENUE, SUITE 1220, PHOENIX, AZ, 85012, US

(21) Appl. No.: 11/084,418

(22) Filed: Mar. 18, 2005

(51) Int. Cl. F02B 53/00

(52) U.S. Cl. 123/241

(57) ABSTRACT

A rotary engine includes a housing with at least one housing chamber formed in an inner surface of the housing. The rotary engine also includes a rotor rotatably mounted within the housing. At least one rotor chamber is formed in an outer surface of the rotor. The at least one housing and rotor chambers form a combustion chamber when adjacent to each other.

### BACKGROUND OF THE INVENTION

1. Field of the Invention

The present invention relates generally to internal combustion engines, and more particularly, to rotary engines.

2. Related Art and Prior Art Statement

Engines are typically used to convert electrical or chemical energy into energy of motion which can be used to do work. An internal combustion engine is one type of engine that converts chemical energy into energy of motion. There are several different types of internal combustion engines, such as piston and rotary engines, and each has its own advantages and disadvantages because they work in different ways. For example, piston engines provide power in response to the back and forth motion of a piston which is driven by the combustion of fuel in a cylinder. The piston is coupled to a crankshaft which rotates in response to the back and forth motion of the piston so that this motion is converted to circular motion. The crankshaft's circular motion can then be used to do work. A rotary engine, on the other hand, provides power in response to the motion of a rotor. The rotor is moved by the combustion of fuel which causes the rotor to rotate inside a chamber. Conventional rotary engines typically include triangular shaped rotors which have three points that contact an inner surface of the chamber. The space between the rotor and the inner surface of the chamber define three separate volumes of space which are sealed from each other by the points of the triangular rotor. Each volume of space provides different functions as the rotor spins inside the chamber. For example, one volume of space provides combustion, another volume provides compression, and the third volume provides exhaustion. As the rotor rotates within the chamber, each of the three volumes of gas alternately expands and contracts. It is this expansion and contraction that draws air and fuel into the engine, compresses it, combusts it, and then expels the exhaust.

However, while prior art rotary engines may be suitable for their intended purposes, they leave much to be desired from the standpoint of efficiency and simplicity. As a result, there is a need for an improved rotary engine.

### BRIEF SUMMARY OF THE INVENTION

The present invention provides a rotary engine which includes a housing with one or more housing chambers formed in its inner surface. The rotary engine also includes a rotor rotatably mounted within the housing. One or more rotor chambers are formed in an outer surface of the rotor. The housing and rotor chamber(s) form one or more combustion chambers when adjacent to each other.

The present invention also provides a rotary engine which includes a housing with a housing chamber formed in its inner surface. The rotary engine also includes a rotor positioned within the housing and mounted so it can rotate therein. The rotor is positioned so that its outer surface rides against the inner surface of the housing. A rotor chamber is formed in the outer surface of the rotor so that the rotor chamber is movable between a first position adjacent to the housing chamber and a second position away from the housing chamber.

The present invention further provides an engine system which includes a rotary engine having a housing that bounds a housing space. The housing includes a plurality of housing chambers, each of which extends into an inner surface of the housing and opens up into the housing space. The housing chambers are spaced equidistance from each adjacent housing chamber. The rotary engine also includes a rotor positioned within the housing space so that the rotor substantially occupies it. The rotor is mounted so that it can rotate therein and its outer surface rides against the inner surface of the housing. The rotor includes a plurality of rotor chambers formed in the outer surface of the rotor.

The rotor chambers are movable between a first position adjacent to corresponding housing chambers where the housing and rotor chambers form a combustion chamber and a second position away from the housing chambers. The rotor chambers are shaped so that the rotor rotates in response to combustion in the combustion chambers. The rotor chambers are spaced equidistance from each adjacent rotor chamber. The engine system also includes a drive shaft coupled to the rotor and a fuel system which provides fuel to the housing chamber when the rotor chambers are in the first position.

These and other features, aspects, and advantages of the present invention will become better understood with reference to the following drawings, description, and claims.

### BRIEF DESCRIPTION OF THE DRAWINGS

Referring to the drawings:

FIG. 1 is a simplified front view of an engine system in accordance with the present invention;

FIG. 2 is a simplified left side view of the engine system of FIG. 1;

FIG. 3 is a simplified perspective view of the engine system in FIG. 1, portions thereof broken away and shown in section;

FIG. 4A is a simplified sectional view of the rotary engine included in the engine system of FIG. 1, taken from the line 4A-4A of FIG. 1;

FIG. 4B is a simplified sectional view of the rotary engine included in the engine system of FIG. 1, taken from the line 4B-4B of FIG. 1;

FIG. 5 is a sectional view taken along a cut-line 5-5′ of FIG. 4A, looking in the direction of the arrows;

FIG. 6 is a simplified perspective view of another embodiment of a rotary engine that includes cooling fins; and

FIG. 7 is a simplified side view of another embodiment of an engine system in accordance with the present invention.

### DETAILED DESCRIPTION OF THE INVENTION

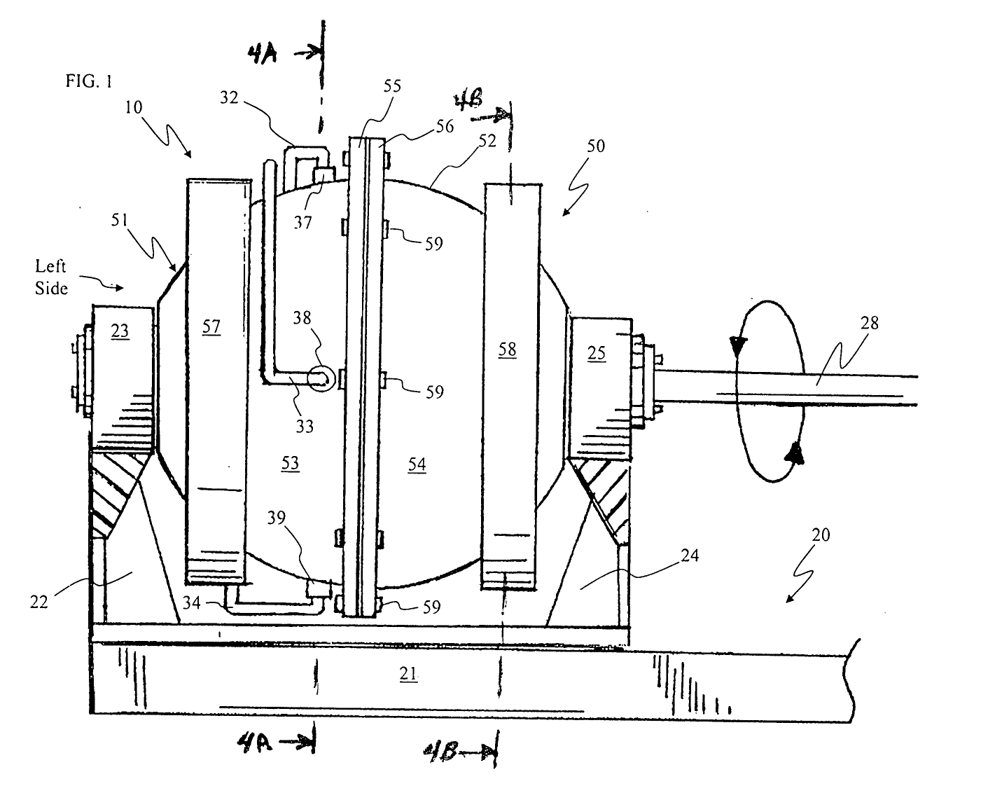

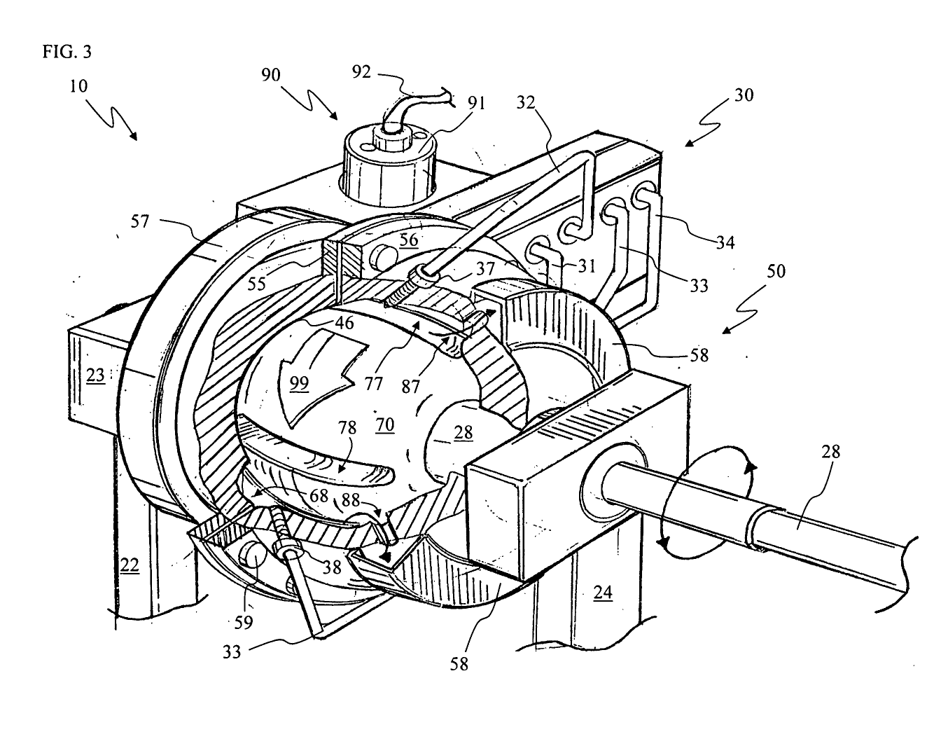

Turn now to FIGS. 1-3 which show various views of an engine system 10 in accordance with the present invention. FIGS. 1, 2, and 3 are simplified front, left side, and perspective views, respectively, of engine system 10. In FIG. 3, a portion of engine system 10 is shown in a partial cut-away view. Engine system 10 can be included in many different types of systems, such as a vehicle or a generator, to convert chemical energy to mechanical or electrical energy to do work. Engine system 10 can be fabricated using conventional materials and techniques typically used to build engines.

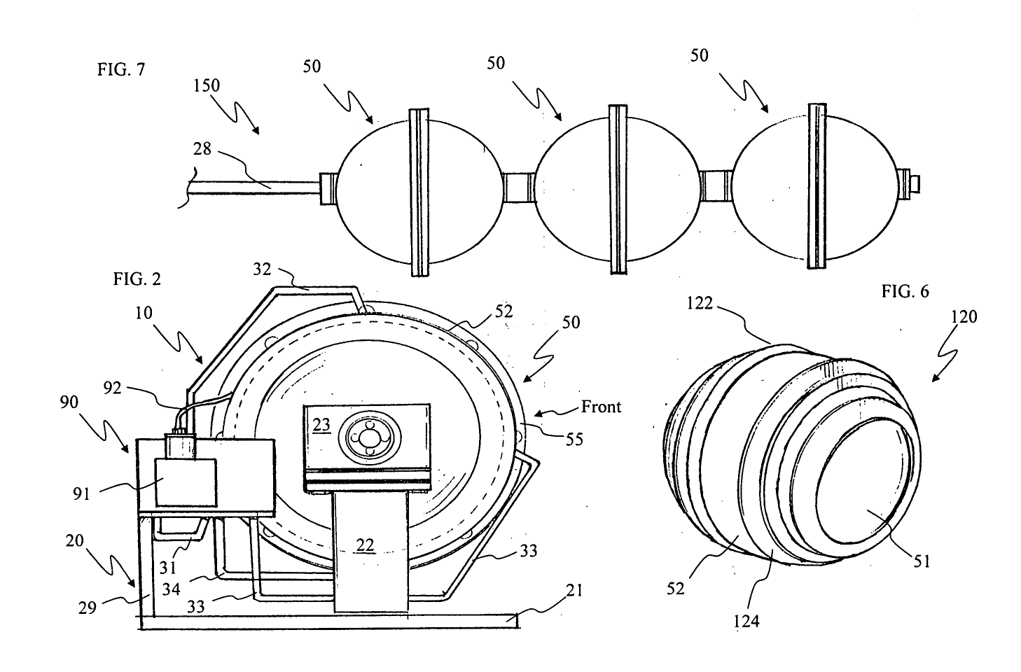

In one embodiment, engine system 10 includes a rotary engine 50 carried by a support structure 20. A fuel system 30 provides fuel to rotary engine 50 and an ignition system 90 ignites the fuel therein (See FIGS. 2-3). The fuel can include many different types, but is typically a hydrocarbon or hydrogen based fuel with an oxidizing gas, such as air or oxygen mixed with water vapor. A drive shaft 28 is coupled to rotary engine 50 and rotates in response to the ignition of the fuel. For vehicle systems, shaft 28 can be coupled to a drive train (not shown) in a known manner so that its rotational energy is converted to energy of motion. For generator systems, shaft 28 can be used to rotate a magnetic coil to provide electrical energy in a known manner. An exhaust system (not shown) removes exhaust from rotary engine 50 provided by the combustion of the fuel.

Support structure 20 can have many different configurations so that it holds rotary engine 50 and dampens vibrations caused by the rotation of the various parts included therein. In this embodiment, support structure 20 includes arms 22 and 24 which extend up from a base 21. Brackets 23 and 25 are held by arms 22 and 24, respectively, and rotary engine 50 is held between brackets 23 and 25 above base 21. In this example, drive shaft 28 extends through bracket 25 where it is coupled to rotary engine 50. Accordingly, bracket 25 includes bearings (not shown) so that drive shaft 28 is held in place and can rotate without rotating bracket 25. Support structure 20 also includes an arm 29 (FIG. 2) coupled to base 21, where arm 29 supports fuel system 30 and ignition system 90.

In this embodiment, rotary engine 50 includes a housing 51 which can have many different shapes, such as simple geometric shapes, and cylindrical, but in this embodiment housing 51 is spherical. Here, housing 51 includes hemispheres 53 and 54 which have flanges 55 and 56, respectively, positioned so that they can be coupled together to form spherical housing 51. Flanges 55 and 56 can be coupled together in many different ways such as with fasteners or by welding. In this embodiment, flanges 55 and 56 are coupled together by bolts 59 which extend through flanges 55 and 56. When flanges 55 and 56 are coupled together, there is an air-tight seal between them and hemispheres 53 and 54. In this way, housing 51 bounds a housing space and defines a peripheral outer surface 52 and a peripheral inner surface 46.

In this example, fuel system 30 and ignition system 90 are of known types and are both carried by arm 29 (FIG. 2) of support structure 20, although they can be otherwise positioned. Fuel system 30 provides fuel to rotary engine 50 through fuel lines 31-34 (FIGS. 1-3). Fuel lines 31-34 are coupled to rotary engine 50 through corresponding fuel inlets 36-39. Fuel inlets 36-39 extend through housing 51 and are coupled to corresponding housing chambers 66-69. Ignition system 90 includes a coil 91 which provides an electrical signal through a wire 92 in a known manner to each fuel inlet 36-39, as will be discussed in more detail below. In this way, fuel inlets 36-39 inject fuel into corresponding housing chambers 66-69 and ignite it at the appropriate time, which will be described presently.

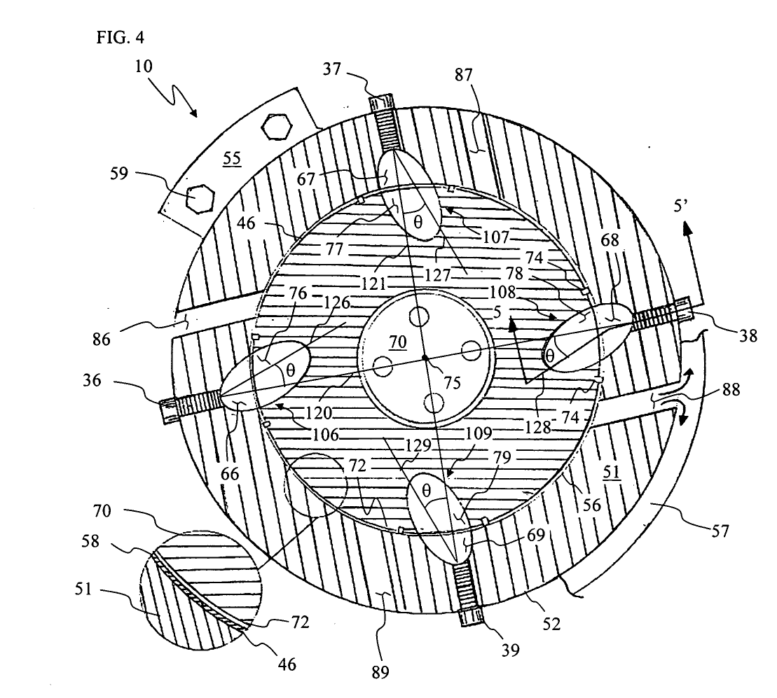

FIG. 4A is a simplified sectional view of rotary engine 50 from the perspective shown in FIG. 1. In accordance with the invention, rotary engine 50 includes one or more housing chambers which extend into peripheral inner surface 46 of housing 51. In this particular example, rotary engine 50 includes four housing chambers 66-69 which are in communication with the housing space and open up into it. Housing chambers 66-69 can have many different shapes, but are oblong and extend lengthwise between hemispheres 53 and 54 in this example so that they are substantially perpendicular to flanges 55 and 56. Housing chambers 66-69 are positioned an equal distance apart so that housing chambers 66 and 68 are positioned opposite each other and housing chambers 67 and 69 are positioned opposite each other. In this way, housing chambers 66-69 are spaced equidistant from each adjacent housing chamber around inner surface 46 of housing 51.

In this embodiment, a rotor 70 is mounted within housing 51 so that it substantially occupies the housing space of housing 51. Rotor 70 substantially occupies the housing space so that its outer surface 72 rides against inner surface 46 of housing 51. Hence, the shape of rotor 70 is chosen to match the shape of housing 51. Rotor 70 is also mounted so that it can rotate therein the housing space of housing 51. Rotor 70 is coupled to drive shaft 28 so that drive shaft 28 rotates in response to the rotation of rotor 70. In accordance with the invention, rotor 70 includes rotor chambers formed in outer surface 72 of rotor 70. In this particular example, rotary engine 50 includes four rotor chambers 76-79 which face outwardly towards housing 51. Rotor chambers 76-79 can have many different shapes, but are oblong and extend lengthwise between hemispheres 53 and 54 in this example so that they are substantially perpendicular to flanges 55 and 56. Rotor chambers 76-79 are positioned an equal distance apart so that rotor chambers 76 and 78 are positioned opposite each other and rotor chambers 77 and 79 are positioned opposite each other. In this way, rotor chambers 76-79 are spaced equidistant from each adjacent rotor chamber around outer surface 72 of rotor 70.

It should be noted that rotary engine 50 can include one or more rotor chambers depending on the amount of power desired and that four rotor chambers are shown here for illustrative purposes. In general, the amount of power provided by engine 50 increases with the number of rotor chambers. It should also be noted that the number of rotor chambers included in rotary engine 50 is generally the same number as housing chambers or fuel inlets. Hence, since there are four housing chambers as discussed above, there are four rotor chambers and four fuel inlets. As will be discussed in more detail below, the positioning of rotor chambers 76-79 is chosen so that they line up with corresponding housing chambers 66-69 to form combustion chambers 106-109 when fuel is injected into housing chambers 66-69. In this way, rotor chambers 76-79 and housing chambers 66-69 operate as cylinders for combustion, driving the rotation of rotor 70. The appropriate time of ignition occurs when rotor chambers 76-79 and housing chambers 66-69 are adjacent with each other to form combustion chambers 106-109 (See FIG. 4A). In response to the ignition of the compressed combustible gas mixture, rotor 70 rotates in the direction of arrow 99, as shown in FIG. 3.

In this embodiment, rotary engine 50 also includes exhaust ports 86-89 positioned proximate to housing chamber 66-69, respectively, as shown in FIG. 4B. Exhaust ports 86-89 are carried by hemisphere 54 and extend between surfaces 52 and 46. Exhaust ports 86-89 are positioned equidistance around inner surface 46 of housing 51 so that ports 86 and 88 are opposite each other and ports 87 and 89 are opposite each other. Corresponding exhaust ports are carried by hemisphere 53, but are not visible in FIGS. 4A or 4B. Exhaust ports 86-89 are coupled to an exhaust housing 58 and the corresponding exhaust ports carried by hemisphere 53 are coupled to an exhaust housing 57. Exhaust housings 57 and 58 extend around the outer periphery of hemispheres 53 and 54, respectively, on surface 52. An exhaust system (not shown) is positioned outside housing 51 and coupled to exhaust ports 86-89 and the exhaust ports carried by hemisphere 53 through exhaust housings 57 and 58. The exhaust system can be carried by support structure 20 or it can be otherwise positioned.

In accordance with the invention, rotor chambers 76-79 are movable between several different positions relative to housing chambers 66-69, exhaust ports 86-89, and the exhaust ports carried by hemisphere 54. As best seen in FIG. 4A, during a certain time interval when rotor 70 is spinning, rotor chambers 76-79 are adjacent to housing chambers 66-69 to form corresponding combustion chambers 106-109. During that time interval, rotor chambers 76-79 are adjacent to exhaust ports 86-89, as shown in FIGS. 3 and 4B. When rotor chambers 76-79 are not adjacent to housing chambers 66-69 and exhaust ports 86-89, they face inner surface 46 of housing 51.

In operation, fuel system 30 provides fuel to housing chambers 66-69 through gas inlets 36-39 when rotor chambers 76-79 are adjacent to them. Housing chambers 66-69 are adjacent to rotor chambers 76-79 when they are in communication with each other. For example, as shown in FIG. 4A, at this point in the rotation of rotor 70, rotor chamber 76 is adjacent to housing chamber 66 to form combustion chamber 106, rotor chamber 77 is adjacent to housing chamber 67 to form combustion chamber 107, rotor chamber 78 is adjacent to housing chamber 68 to form combustion chamber 108, and rotor chamber 79 is adjacent to housing chamber 69 to form combustion chamber 109. During this time, fuel inlets 36-39 operate as fuel injectors and fuel igniters by injecting fuel into combustion chambers 106-109, respectively, and igniting it. The ignition of the fuel in combustion chambers 106-109 causes rotor 70 to rotate in a counter clockwise direction as seen from drive shaft 28 and as indicated by arrow 99, although rotor 70 can rotate in a clockwise direction in other examples.

In this example, rotor 70 rotates in the counter clockwise direction because combustion chambers 106-109 are tilted relative to reference lines 120 and 121 which bisect rotor 70. As best seen in FIG. 4A, reference line 120 extends between gas inlets 36 and 38 and through an axis of rotation 75 of rotor 70. Similarly, reference line 121 extends between gas inlets 37 and 39 and through axis of rotation 75 of rotor 70. Axis of rotation 75 extends through the center of rotor 70 in a direction parallel to drive shaft 28. Combustion chambers 106-109 are tilted relative to reference line 120 because combustion chambers 106-109 each have a major axis that is tilted at a non-zero angle θ relative to reference lines 120 or 121. The angle of inclination of combustion chambers 106-109 is an angle most efficient for converting the forces of combustion to rotation of rotor 70 in view of the number of chambers employed. In this example, major axes 126 and 128 of combustion chambers 106 and 108, respectively, extend at the angle θ relative to reference line 120. Similarly, major axes 127 and 129 of combustion chambers 107 and 109, respectively, extend at the angle θ relative to reference line 121. Accordingly, rotor chambers 76-79 and housing chambers 66-69 are shaped so that when they are adjacent to each other, rotor 70 rotates in the direction of arrow 99 in response to combustion within combustion chambers 106-109.

Each rotor chamber 76-79 is sealed from each adjacent rotor chamber as rotor 70 rotates about axis 75. The seal can be provided in many different ways. As shown in FIG. 4, the seal can be provided by positioning a seal ring 74 around the outer periphery of each rotor chamber 76-79. In this way, rotor chambers 76-79 are sealed with housing chambers 66-69 when combustion chambers 106-109 are formed. In this example, each seal ring 74 is carried by rotor 70 so that seal rings 74 are in substantially continuous gas-sealing engagement with inner surface 46 of housing 51 as rotor 70 rotates within and relative to housing 51. Hence, rotor chambers 7.6-79 cooperate with inner surface 46 of housing 50 and housing chambers 66-69 to effectively define therebetween separate working chambers (i.e. combustion chambers 106-109) separated by sealing members 74.

In other embodiments, as shown in the inset of FIGS. 4A or 4B, the seal can be provided by a seal coating material 73 deposited on inner surface 46 of housing 51 between each adjacent housing chamber 66-69. It should be noted, however, that seal coating material 73 could be positioned on outer surface 72 of rotor 70 between each adjacent rotor chamber 76-79 in other embodiments. Further, a combination of seal coating material 73 and seal rings 74 can be used to isolate each rotor chamber 76-79 from each adjacent rotor chamber.

The material included in seal coating material 73 can be deposited on surface 46 and/or 72 or it can be material provided by the byproducts of the combustion which occurs in combustion chambers 106-109. During the combustion of the fuel mixture within combustion chambers 106-109, a portion of the combusted mixture can become deposited onto surfaces 46 and/or 72 as rotor 70 rotates. The build-up of this film on surfaces 46 and/or 72 can increase the power output and efficiency of rotary engine 50 because it reduces blow-back between adjacent rotary chambers.

After the fuel in combustion chambers 106-109 ignites, it expands rapidly in all directions. Because exhaust ports 88 and 98 (see FIG. 3) are positioned in communication with opposite ends of combustion chamber 108, the pressure at the ends is reduced with the major pressure being against the sides of rotor chamber 78 and rotor 70 rotates so that rotor chambers 76-79 face inner surface 46. During this time interval, rotor chamber 76 faces inner surface 46 adjacent housing chamber 66 and exhaust port 86, rotor chamber 77 faces inner surface 46 adjacent housing chamber 67 and exhaust port 87, rotor chamber 78 faces inner surface 46 adjacent housing chamber 68 and exhaust port 88, and rotor chamber 79 faces inner surface 46 adjacent housing chamber 69 and exhaust port 89.

As rotor 70 keeps rotating, the expanding gases in rotor chambers 76-79 eventually are expelled through exhaust ports 86-89 where the exhaust gas included in rotor chambers 76-79 is outgassed by the exhaust system through exhaust housings 57 and 58 in a known manner. Here, the exhaust gas in rotor chamber 76 is outgassed through exhaust port 86 and its corresponding exhaust port carried by hemisphere 54, the exhaust gas in rotor chamber 77 is outgassed through exhaust port 87 and its corresponding exhaust port carried by hemisphere 54, the exhaust gas in rotor chamber 78 is outgassed through exhaust port 88 and its corresponding exhaust port carried by hemisphere 54, and the exhaust gas in rotor chamber 79 is outgassed through exhaust port 89 and its corresponding exhaust port carried by hemisphere 54. As described above, exhaust ports 86-89 are coupled to exhaust housing 57 and the corresponding exhaust ports carried by hemisphere 54 are coupled to exhaust housing 58.

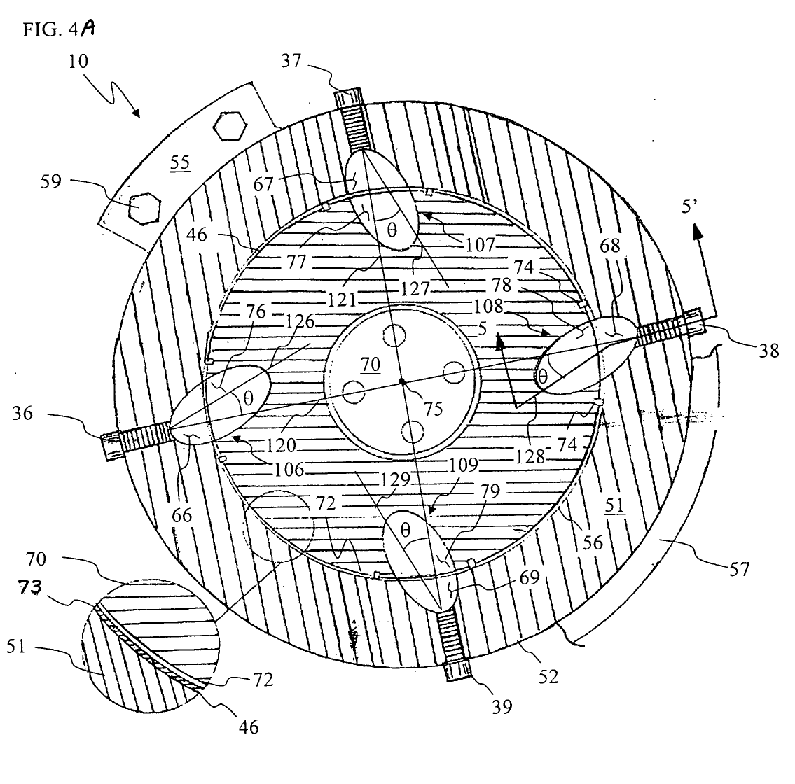

FIG. 5 is a sectional view taken along a cut-line 5-5′ of FIG. 4B to show in more detail the outgassing of the exhaust from rotor chamber 78. Here, rotor chamber 78 is aligned with exhaust port 88 so that a portion of the exhaust gas in rotor chamber 78 is outgassed through exhaust port 88 and into exhaust housing 57. Similarly, rotor chamber 78 is also aligned with a corresponding exhaust port 98 carried by hemisphere 53 (see FIG. 5) so that another portion of the exhaust gas in rotor chamber 78 is outgassed through exhaust port 98 and into exhaust housing 58. The exhaust gas in exhaust housings 57 and 58 is then removed by the exhaust system (not shown) in a manner known in the art. For example, the exhaust gas can be removed from rotor chamber 78 in response to a pressure difference between rotor chamber 78 and exhaust housings 57 and 58 provided by the exhaust system. It should be noted that the exhaust gas from rotor chambers 76, 77, and 79 is removed in a similar manner.

After the exhaust gas is outgassed by the exhaust system, rotor 70 moves so that rotor chambers 76-79 once again face inner surface 46. During this time interval, rotor chamber 76 faces inner surface 46 adjacent housing chamber 67 and exhaust port 86, rotor chamber 77 faces inner surface 46 adjacent housing chamber 68 and exhaust port 87, rotor chamber 78 faces inner surface 46 adjacent housing chamber 69 and exhaust port 88, and rotor chamber 79 faces inner surface 46 adjacent housing chamber 66 and exhaust port 89.

Combustion chamber 106 is formed by housing chamber 66 and rotor chamber 79, combustion chamber 107 is formed by housing chamber 67 and rotor chamber 76, combustion chamber 108 is formed by housing chamber 68 and rotor chamber 77, and combustion chamber 109 is formed by housing chamber 69 and rotor chamber 78. The sequence is then repeated so that fuel system 90 injects fuel into combustion chambers 106-109 through corresponding fuel inlets 36-39. The fuel is then ignited so that rotor 70 keeps rotating. In this way, rotor chambers 76-79 alternate between being adjacent to housing chambers 66-69, surface 46, and exhaust ports 86-89 in a sequential manner to provide combustion, compression, and exhaustion, respectively, so that rotor 70 rotates in response. As rotor 70 keeps rotating, rotor chambers 76-79 eventually face housing chambers 86-89 again to form combustion chambers 106-109.

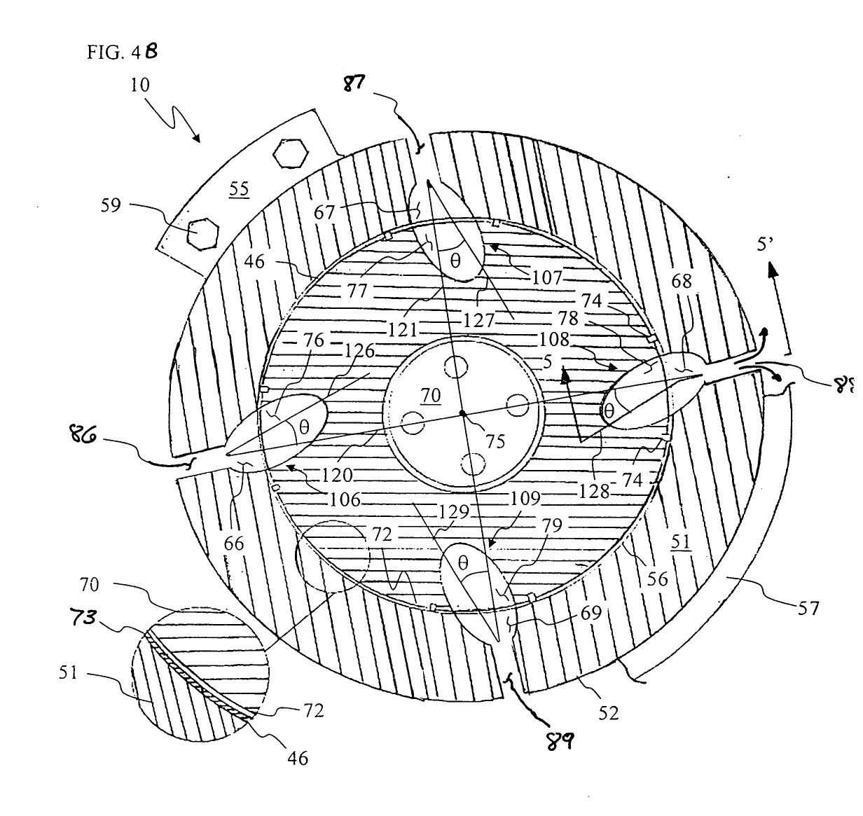

FIG. 6 is a simplified perspective view of another embodiment of a rotary engine 120 that is similar to rotary engine 50 discussed above. The combustion of the fuel mixture within housing chambers 66-69 and rotor chambers 76-79 can significantly increase the temperature of rotary engine 120 which reduces its efficiency. Accordingly, rotary engine 120 includes a cooling system to reduce its temperature. In accordance with the invention, the cooling system can have many different configurations. In one embodiment, the cooling system includes cooling fins 122 and 124 positioned around the outer periphery of housing 51. Here, cooling fins 122 and 124 are positioned on outer surface 52 of housing 51. Cooling fins 122 and 124 are designed to increase the heat dissipation of rotary engine 120 by increasing the area of surface 52 so that it operates at a lower temperature and, consequently, at a higher efficiency. In other examples, the cooling system can include cooling lines that extend through rotary engine 50 to reduce its temperature. For example, the cooling lines can extend through housing 51 so that the cooling lines flow a coolant, such as water, therethrough housing 51.

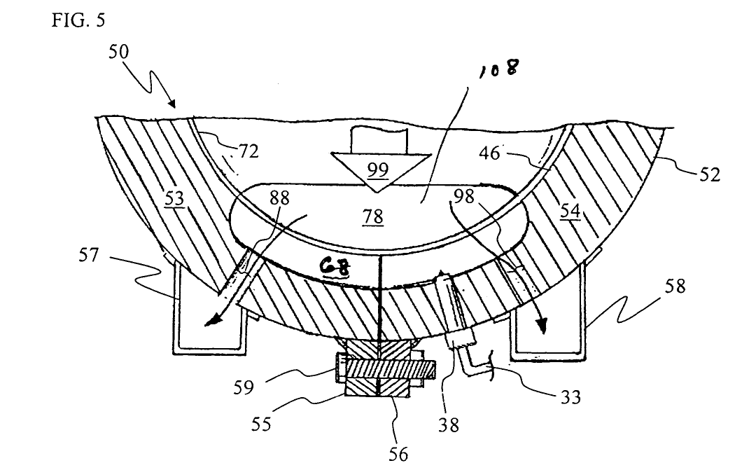

FIG. 7 is a simplified side view of another embodiment of an engine system in accordance with the present invention. As discussed above, the number of housing chambers and corresponding rotor chambers determines the amount of power provided by rotary engine 50. If the number of housing and rotor chambers increases, then the power provided by rotary engine 50 also increases. Hence, one way to increase the power provided by engine 50 is to increase the number of housing and rotor chambers included in chamber space 52. Another way to increase the amount of power provided by engine 50 is to couple a number of them to drive shaft 28. As shown in FIG. 7, three rotary engines 50 are coupled to drive shaft 28. Rotary engines 50 are coupled so that they work together to rotate drive shaft 28 faster than would be possible with fewer rotary engines. Of course, any number of rotary engines can be coupled to drive shaft 28 and the illustration of three rotary engines in FIG. 7 is for illustrative purposes.

The present invention is described above with reference to preferred embodiments. However, those skilled in the art will recognize that changes and modifications may be made in the described embodiments without departing from the nature and scope of the present invention. Various further changes and modifications will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A rotary engine, comprising:
a housing defining an enclosed spherical housing space;
a housing chamber formed in an inner surface of the housing within the spherical housing space;
a rotor rotatably mounted within the spherical housing space; and
a rotor chamber formed in an outer surface of the rotor;
the housing chamber and the rotor chambers forming a combustion chamber when in communication with each other.

2. The engine of claim 1, further including a fuel inlet coupled to the housing chamber.

3. The engine of claim 1, wherein a major axis of the combustion chamber is at a non-zero angle relative to a reference line which bisects the rotor.

4. The engine of claim 1, further including an outlet port in communication with the housing chamber.

5. (canceled)

6. The engine of claim 1, wherein the outer surface of the rotor rides against the inner surface of the housing.

7. The engine of claim 1, further including a seal positioned around the rotor chamber so that the housing chamber and the rotor chambers are sealed together when adjacent to each other.

8. A rotary engine, comprising:
a housing defining an enclosed spherical housing space;
a housing chamber formed in an inner surface of the housing within the spherical housing space;
a spherical rotor positioned within the spherical housing space and rotatably mounted therein, an outer surface of the rotor riding against the inner surface of the spherical housing space;
a rotor chamber formed in the outer surface of the rotor, the rotor chamber being movable between a first position adjacent to the housing chamber and a second position away from the housing chamber; and
an exhaust port and a fuel inlet port positioned in communication with the housing chamber.

9. (canceled)

10. (canceled)

11. The engine of claim 8, wherein the rotor chamber is sealed with the housing chamber and exhaust port.

12. The engine of claim 8, further including a plurality of rotor and housing chambers, the rotor chambers being positioned around and formed in the outer surface of the rotor and the housing chambers being positioned around and formed in the inner surface of the housing.

13. The engine of claim 8, wherein the rotor and housing chambers form a combustion chamber when adjacent to each other.

14. The engine of claim 13, wherein the rotor chamber is shaped and the exhaust port is positioned so that the rotor rotates in response to combustion in the combustion chamber.

15. An engine system, comprising:
a rotary engine having
a housing that bounds a spherical housing space;
a plurality of arcuate housing chambers each of which extends into an inner surface of the housing and opens up into the housing space, the housing chambers being spaced equidistance from each adjacent housing chamber and extending in a direction generally perpendicular to a direction of motion;
a spherical rotor positioned within the spherical housing space so that the spherical rotor substantially occupies the spherical housing space, the spherical rotor being mounted for rotation within the spherical housing space, an outer surface of the spherical rotor riding against the inner surface of the spherical housing space;
a plurality of arcuate rotor chambers formed in the outer surface of the spherical rotor and extending in a direction generally perpendicular to a direction of motion, the rotor being movable between a first position wherein each of the rotor chambers is adjacent to a corresponding housing chambers, where each of the plurality of housing chambers and corresponding each of the plurality of rotor chambers form a combustion chamber, and a second position wherein the rotor chambers are moved away from the housing chambers;
a plurality of exhaust ports, one each positioned in communication with one each of the plurality of housing chambers;
wherein the rotor chambers are shaped and the exhaust ports are positioned so that the rotor rotates in response to combustion in the combustion chambers, the rotor chambers being spaced equidistance from each adjacent rotor chamber;
a drive shaft coupled to the rotor; and
a fuel system which provides fuel to the housing chamber when the rotor chambers are in the first position.

16. (canceled)

17. (canceled)

18. The system of claim 15, further including an exhaust system positioned outside the housing chamber and coupled to each exhaust port.

19. The engine of claim 15, further including a plurality of rotary engines coupled together to rotate the drive shaft.

20. The system of claim 15, further including a cooling system positioned on an outer surface of the housing.
